(19) United States
(12) Patent Application Publication
(10) Pub. No.: US 2010/0079365 A1
(43) Pub. Date: Apr. 1, 2010

(54) Methods and systems for LED backlight white balance

(75) Inventors: Xiao-fan Feng, Vancouver, WA (US); Kohji Fujiwara, Nara (JP)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 12/462,300

(22) Filed: Jul. 30, 2009

Related U.S. Application Data
(63) Continuation-in-part of application No. 12/242,837, filed on Sep. 30, 2008.

(51) Int. Cl. G09G 3/36

(52) U.S. Cl. 345/102

(57) ABSTRACT

Aspects of the present invention relate to systems and methods for performing white balance operations for an LED display backlight. One method comprises obtaining display parameters and capturing sensor data for a display. Geometrical calibration between the captured sensor data and the display is performed. Color conversion matrices for the display backlight may also be calculated. The backlight is displayed at a selected white value and measurement of the actual color of the backlight is then performed. Next a target luminance is determined based on the measured backlight color and minimization of visible luminance variation. A target color is then determined and used to determine a color difference between the measured backlight color and the target color. From this a normalized RGB color difference and RGB color difference driving values are determined. New RGB driving values based on the RGB color difference values and original driving values are then determined.

### CROSS-REFERENCE TO RELATED APPLICATIONS

This application is a continuation-in-part of U.S. patent application Ser. No. 12/242,837, filed Sep. 30, 2008.

### BACKGROUND OF THE INVENTION

The present invention relates to backlights for a display.

Some displays, such as LCD displays, have backlight arrays with individual elements that can be individually addressed and modulated. In some cases, the backlight arrays include light emitting diodes either illuminating directly forward, or arranged along the edges of the display and reflected forward. The displayed image characteristics can be improved by systematically addressing backlight array elements.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a liquid crystal display with a light emitting diode backlight array.

FIG. 2 illustrates a white balance technique.

FIG. 3 illustrates a geometric test pattern.

FIG. 4 illustrates a filtering technique to select target luminance values.

FIG. 5 illustrates a contrast sensitivity function of the human visual system.

FIG. 6 illustrates display geometry and sampling dimensions.

FIG. 7 illustrates an iterative technique for determining a backlight driving value difference.

FIG. 8 illustrates a modified white balance technique.

### DETAILED DESCRIPTION OF PREFERRED EMBODIMENT

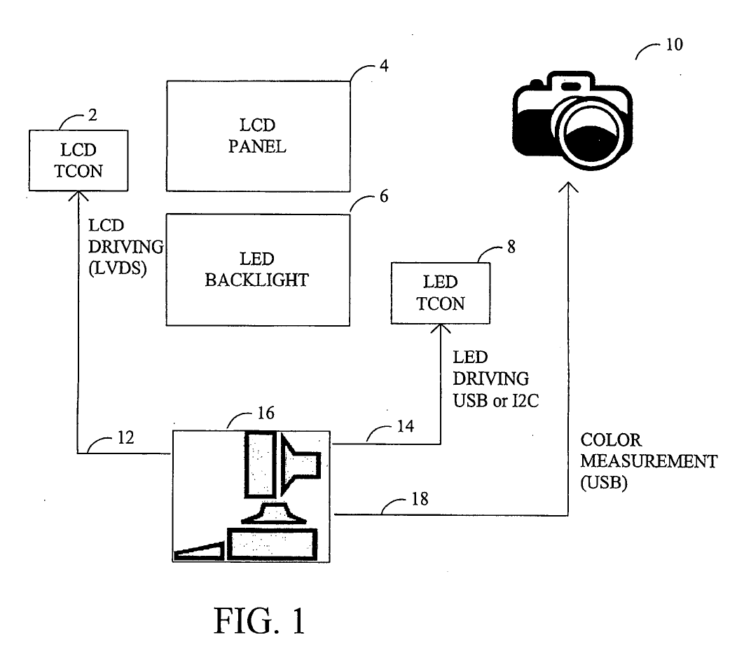

FIG. 1 illustrates an exemplary light emitting diode based white balance system. Other illumination elements may likewise be used. A computing device 16, such as a personal computer, may control liquid crystal display control circuitry 2 for an associated liquid crystal display (LCD) panel 4, light emitting diode (LED) control circuitry 8 for an associated LED backlight 6, and an imaging device 10. The imaging device may be any type of camera or sensing device. The computing device 16 may communicate with other devices through connections, 12, 14, and 18, which may be wired and/or wireless. The imaging device 10 is typically connected to the computing device 16 using a universal serial bus (USB) connection. The computing device 16 is typically connected to the LED control circuitry 8 with a USB connection, a video cable connection such as a digital visual interface (DVI) connection, a video graphics array (VGA) cable or some other connection 14. The computing device 16 is typically connected to the LCD control circuitry 2 with a USB connection, a video cable connection such as a digital visual interface (DVI) connection, a video graphics array (VGA) connection or some other connection 12. The computing device 16 is sometimes connected to the imaging device 10, LCD control circuitry 2 and/or the LED control circuitry 8 with a wireless connection. In general, the various devices may be interconnected to any other device using any mechanism.

To set the white balance, the LED backlight 6 may be illuminated using initial LED driving values provided to the LED control circuitry 8 from the computing device 16 over the connection 14. The imaging device 10 then senses the light output from the LED backlight 6 and determines the chromaticity of the light from the LCD panel 4 originating with the LED backlight 6. The LCD panel 4 may be omitted, if desired. If the LCD panel 4 is included, it is preferably set to a full white state, but may be set to any desired state. Based on the measurements from the imaging device 10, the LED backlight driving values may be changed to modify the chromaticity of the LED backlight 6. This process may be repeated until the chromaticity sensed by the imaging device 10 is suitable.

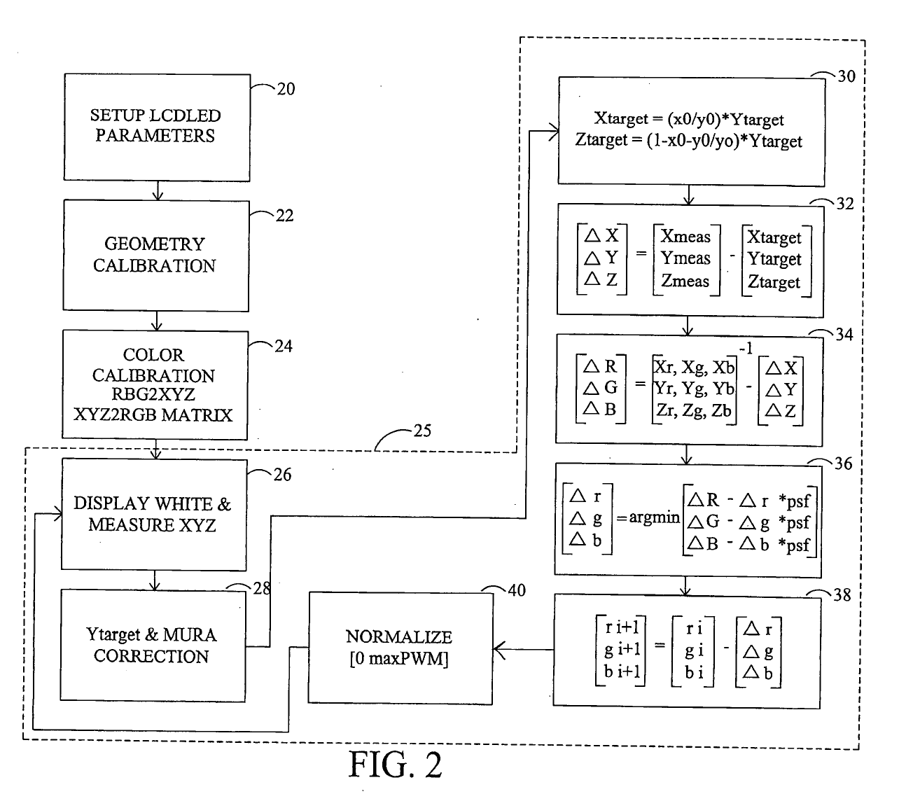

FIG. 2 illustrates another white balance technique for a LED display backlight. Initially, display parameters 20 may be established for the display. These display parameters may be, for example, geometric display parameters, such as the size, the shape, the orientation, and/or the number of LED blocks (LED backlight elements) and/or LCD pixels. Geometrical calibration 22 may also be performed between the captured data and the display. For example, geometrical calibration 22 may include correlating captured camera pixels to display LED positions.

Color calibration 24 may also be performed. The color calibration 24 may include calculation of one or more color conversion matrices, such as an RGB to an XYZ matrix and its inverse XYZ to RGB matrix. RGB refers to the primary colors, although other color primaries may be used.

Based upon the color calibration 24, an iterative process 25 may be used to modify the LED backlight while balance or any other suitable color. The iterative process 25 may include illuminating the LED backlight set to a white value or other value, and sensing of the color of different portions of the backlight 26. Based on the measured luminance profile (backlight color), a target luminance may then be determined 28 that reduces the visible luminance variation (e.g., mura). This mura reduction may be based on reduced sensitivity at low spatial frequencies of the human visual system and/or high spatial frequencies of the human visual system.

The target color X and Z may be computed 30 with the desired chromaticity (e.g., x₀ and y₀), such as expressed in equation 1 (below). The difference in XYZ coordinates between the measured XYZ (measured backlight color) and the target XYZ (target color) may also be determined 32, such as expressed in equation 2 (below). The iterative process 25 may continue by obtaining 34 the corresponding normalized RGB, e.g., (normalized RGB color difference), such as expressed in equation 3 (below). De-convolution may be used 36 to determine the LED driving values r, g, and b (rgb color difference driving values), such as expressed in equation 4 (below).

A new LED driving value (rgb driving value) may be determined 38, such as expressed in equation 5 (below). LED driving values may be normalized 40, to a maximum (or other value) pulse width modulation (PWM) so that the LED driving values are not out of range.

This iterative process 25, which includes one or more of the 26, 28, 30, 32, 34, 36, 38, and 40 (see FIG. 2), may be repeated until the target color is reached for the LED white balance or other color.

The LCD panel 4 geometrical calibration 22 may be performed by displaying a grid pattern on the LCD panel 4 while the camera 10 captures the grid pattern and detects the grid position in the captured image.

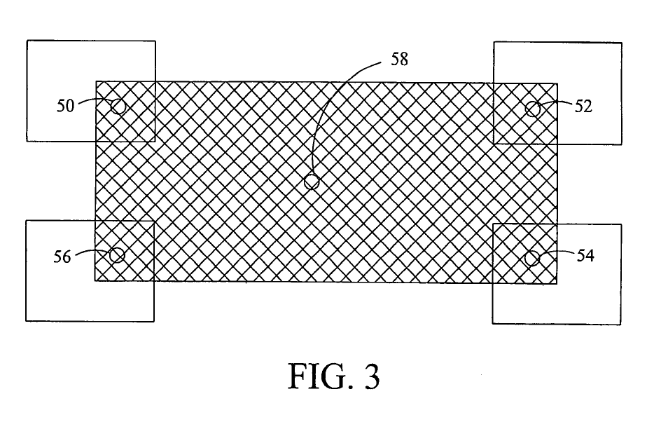

With reference to FIG. 3, four corner LED blocks 50, 52, 54 and 56 (corner backlight elements) may be selected and then sensed by the camera 10. A perspective transformation may be used to map the captured image to the LED backlight position. In addition to the LED backlight position, a center LED 58 or another LED that is spaced apart from the display edge, may also be illuminated. Multiple LEDs may likewise be used. This non-edge or center LED 58 may be used to derive a point spread function (PSF) or other characteristic of the LED backlight 6.

The color calibration 24 may include calculation of one or more color conversion matrices, such as an RGB (drive values) to XYZ (sensed values) matrix and its inverse XYZ to RGB matrix. This process may be performed using the following steps:

(1) Illuminate the R, G, and B backlight LEDs one at a time with R, G, and B backlight LEDs one at a time with R, G, B values (or other backlights);

(2) Sense the illuminated color (X,Y,Z) with a camera;

(3) Average the measured color (XYZ) and determine the RGB to XYZ matrix; and

(4) Calculate the XYZ the RGB matrix as the matrix inversion of the RBG the XYZ matrix.

The XYZ to RGB and RGB to XYZ matrices may be derived for each LED by the driving values and the corresponding measured color values associated with that LED.

The white balance may include the following technique.

(1) Display 26 (FIG. 2) the white or selected color value (set or estimate RGB so that the illumination is close to the target white or selected color value).

(2) Sense the illuminated color of the display (e.g., CIE tri-stimulus values: X, Y, Z, and CIE chromaticity x, y). The measured data may have a spatial resolution higher than the LED resolution.

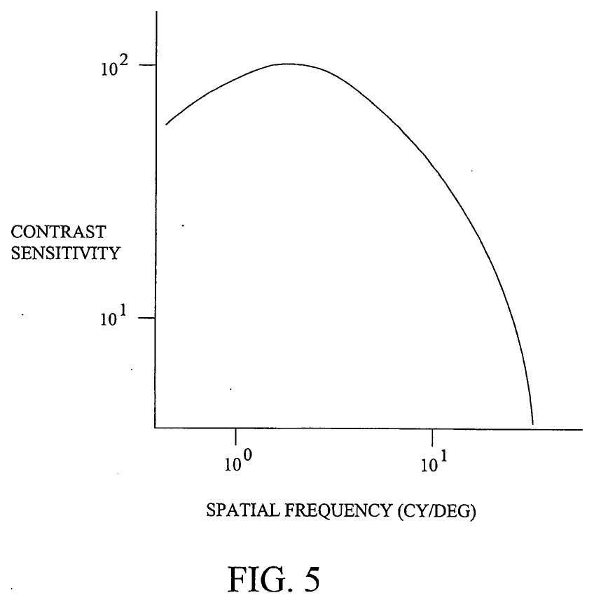

(3) Based on the measured luminance profile, determine 28 a target luminance that reduces the visible luminance variation (e.g., mura). This may be based on the reduced sensitivity at both low spatial frequencies of the human visual system and/or high spatial frequencies of the human visual system as illustrated in FIG. 5. There is limited benefit to modify luminance variations that are not observable by human visual system. For example, these may include the cut-off frequency corresponding to the increase in sensitivity of the human visual system.

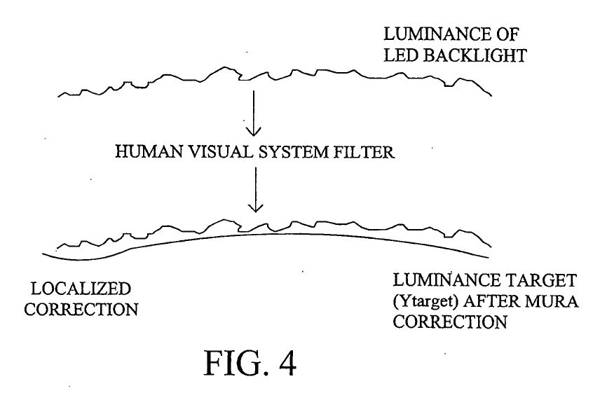

The target luminance may be set to approximately the low-pass-filtered (for example using a Human Visual System Filter) backlight luminance as illustrated in FIG. 4.

The target color X and Z may be computed 30 with the desired chromaticity x₀ and y₀ using the following equation:

$${X}_{target} = \frac{{x}_{0}}{{y}_{0}} {Y}_{target} \\ {Z}_{target} = \frac{1 - {x}_{0} - {y}_{0}}{{y}_{0}} {Y}_{target} \qquad ( 1 )$$

The difference in XYZ coordinates between the measured XYZ and target XYZ may be determined 32 with the following equation:

$$( \begin{matrix}Δ X \\ Δ G \\ Δ Z\end{matrix} ) = ( \begin{matrix}{X}_{meas} \\ {Y}_{meas} \\ {Z}_{meas}\end{matrix} ) - ( \begin{matrix}{X}_{target} \\ {Y}_{target} \\ {Z}_{target}\end{matrix} ) \qquad ( 2 )$$

The corresponding normalized RGB may be obtained 34 with the following equation:

$$( \begin{matrix}Δ R \\ Δ G \\ Δ B\end{matrix} ) = {( \begin{matrix}{X}_{r} {X}_{g} {X}_{b} \\ {Y}_{r} {Z}_{g} {Y}_{b} \\ {Z}_{r} {Z}_{g} {Z}_{b}\end{matrix} )}^{- 1} ( \begin{matrix}Δ X \\ Δ Y \\ Δ Z\end{matrix} ) \qquad ( 3 )$$

De-convolution may be used to determine the LED driving values r, g, and b with the following equation:

$$( \begin{matrix}Δ r \\ Δ g \\ Δ b\end{matrix} ) = arg min \{ \begin{matrix}Δ R - Δ r * psf \\ Δ G - Δ g * psf \\ Δ B - Δ b * psf\end{matrix} \} \qquad ( 4 )$$

Wherein * denotes the convolution operation.

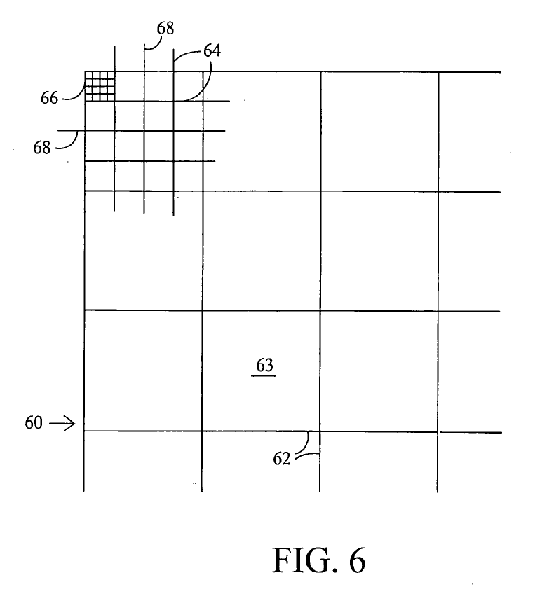

FIG. 6 illustrates the relative geometry of a typical display 60 and various sampling elements. The display 60 may include a backlight array with backlight LED elements having a size defined by backlight grid lines 62 and backlight element cells 63, which are illuminated by a backlight element, such as a single LED. The display 60 may also include an LCD panel with LCD pixels 66, which are typically smaller than the backlight element cells 63. An intermediate grid may also be established at a resolution that is between that of the LCD pixels 66 and the backlight element cells 63. This intermediate sampling grid may be defined by grid lines 64. Sampling at the intermediate resolution may be performed by downsampling the LCD pixel values. The intermediate resolution elements may be qualified as on-grid or off-grid based on their proximity to an LED grid defined by LED grid lines 68 that pass through the center points of the LED elements 63. If an intermediate element is on, adjacent to, or within a specified distance of an LED grid line 68, that element may be considered to be on-grid. If the element does not meet the on-grid criterion, it is considered off-grip. The 26, 28, 30, 32, 34, 36, 38, and 40 may use the intermediate resolution.

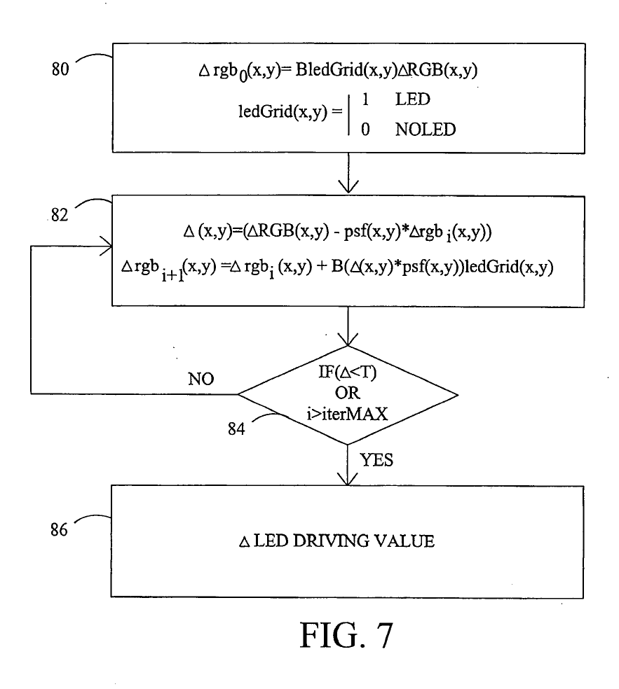

FIG. 7 further illustrates the de-convolution process. Since the de-convolution may be done at a higher intermediate resolution than the LED resolution, each backlight location (x,y) is designated 80 as an LED (on-grid) location (ledGrid=1) or a no-LED (off-grid) location (ledGrid=0). The technique may iteratively change 82 the LED driving value (Δrgb) to reduce the difference {ΔRGB(x,y)−psf(x,y)*Δrgb₁(x,y)}, where * denotes the convolution operation. When a difference threshold is met 84 or a maximum number of iterations is reached, the process may be stopped and a new driving value difference is obtained 86.

A new LED driving value may be determined 38 using the result of equation 4 and the previous (original) driving value used to display the selected white value. This is illustrated in the following equation:

$$( \begin{matrix}{r}_{i + 1} \\ {g}_{i + 1} \\ {b}_{i + 1}\end{matrix} ) = ( \begin{matrix}{r}_{i} \\ {g}_{i} \\ {b}_{i}\end{matrix} ) - ( \begin{matrix}Δ r \\ Δ g \\ Δ b\end{matrix} ) \qquad ( 5 )$$

The LED driving values may be normalized 40 to the maximum pulse width modulation (PWM) so that the LED driving values are not out of range. Steps numbered 26, 28, 32, 34, 36, 38, and 40 in FIG. 2 may then be repeated until the target color is reached for the LED white balance.

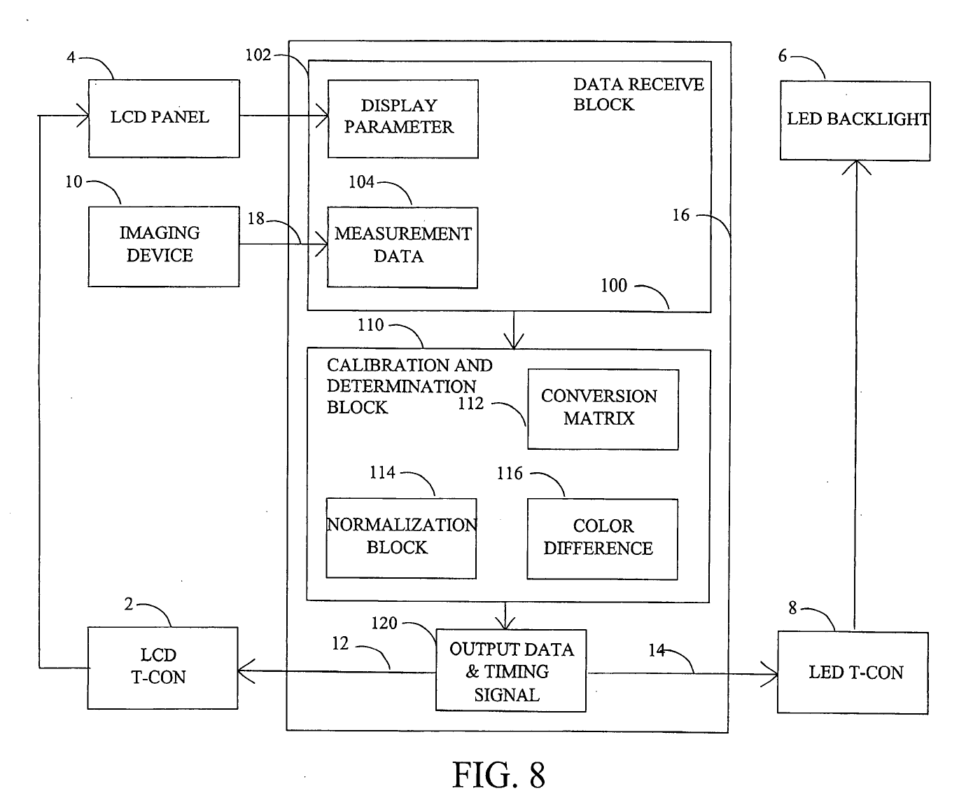

Referring to FIG. 8, the computing device 16 may include several difference components. The computing device 16 may include a data receiving block 100 for receiving data from the imaging device 10 and the LCD panel 4. For example, the data receiving block 100 may receive the data related to the current state 102 of the LCD panel 4. The data may be any suitable form, such as the luminance of the LEDs and/or the geometrical information. The data receiving block 100 may likewise receiving measurement data 104 from the imaging device 10. In this manner, the data receiving block 100 may receiving the inputs for subsequent appropriate adjustment of the display as measurement data 104.

The data receiving block 100 may provide the measurement data 104 and/or display parameters 102 to a calibration and determination block 110. The calibration block 110 may perform the desired calculations to determine the adjustments to properly calibrate the display. Some of the functions that may be performed by the calibration and determination block 110 include, for example, a conversion matrix 112, a normalization block 114, a color difference 116, LED driving values, chromaticity of the LED backlight 6, target luminance, target XYZ (target color), RGB color difference driving values, point spread function (PSF), pulse width modulation (PWM), etc. Other calibration features may likewise be included, such as other calculations using display parameters, modification to reduce mura, chromaticity modification, and those previously described. The calibration and determination block 110 may likewise determine when the target color is reached.

In some cases, the calibration and determination block may include a stored set of initial LED driving values and/or initial display parameters. These initial values and parameters are presumably close to the final values, and thus may shorten down the number of iterations before a desired level is reached.

The resulting data from the calibration block 110 is provided to an output data and timing signal block 120. The output data and timing signal block 120 provides data and timing signals to the LCD2 (if included) and also to the LED 8. In this manner, the display is provided with control information. The process of providing data to the controllers 2, 8 provides control over the LCD panel 4 and LED backlight 6, respectively.

The computing device 16 may receive data from the imaging device 10 (and LCD panel 4), and in turn provide modifications to the LCD 2 and/or the LED 8, in a repetitive process to modify the characteristics of the display.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for modifying a display backlight white balance, said method comprising:
(a) sensing an light output of a multi-colored said backlight of said display;
(b) based upon said sensing determining a modification suitable to adjust the white balance of said backlight;
(c) based upon said modification adjusting said white balance of said backlight.

2. The method of claim 1 wherein said modification is based upon a geometrical calibration.

3. The method of claim 2 wherein said modification is further based upon calculating color conversion matrices.

4. The method of claim 3 wherein said modification is further based upon a reduction in visible luminance variation.

5. The method of claim 4 wherein said modification is further based upon a color difference.

6. The method of claim 5 wherein said color difference is a normalized RGB color difference.

7. The method of claim 1 wherein said sensing and modification is iteratively repeated.

8. The method of claim 1 wherein said modification is performed by a computer.

9. The method of claim 8 wherein said computer includes a data receiving block.

10. The method of claim 9 wherein said computer includes a calibration block.

11. The method of claim 10 wherein said computer includes a determination block.

12. The method of claim 1 wherein said modification is based upon calculations at an intermediate resolution between the backlight resolution and a LCD resolution of said display.

13. The method of claim 1 wherein said modification is based upon a point-spread-function of the backlight.

14. The method of claim 1 wherein said modification is based upon a deconvolution.
